(19) United States
(12) Patent Application Publication
(10) Pub. No.: US 2020/0221005 A1
(43) Pub. Date: Jul. 9, 2020

(54) METHOD AND DEVICE FOR TRACKING PHOTOGRAPHING

(71) Applicant: SZ DJI TECHNOLOGY CO., LTD., Shenzhen (CN)

(72) Inventors: Ye TAO, Shenzhen (CN); Guanliang SU, Shenzhen (CN)

(21) Appl. No.: 16/822,630

(22) Filed: Mar. 18, 2020

Related U.S. Application Data
(63) Continuation of application No. PCT/CN2017/102992, filed on Sep. 22, 2017.

(51) Int. Cl. H04N 5/235; B64C 39/02; B64D 47/08

(52) U.S. Cl. CPC H04N 5/2351; H04N 5/2353; G01S 19/42; B64D 47/08; B64C 39/024

(57) ABSTRACT

A movable device includes: a sensing element configured to obtain position information of a target object; an image acquisition element configured to capture an image containing the target object; and a controller. The controller is configured to adjust an orientation of the image acquisition element to face toward the target object; receive the image from the image acquisition element; control the image acquisition element to perform, according to the position information of the target object, at least one of: setting focus on the target object, or metering the target object.

### CROSS-REFERENCE TO RELATED APPLICATION

This application is a continuation of International Application No. PCT/CN2017/102992, filed Sep. 22, 2017, the entire content of which is incorporated herein by reference.

### TECHNICAL FIELD

The present disclosure relates to image processing and, more particularly, to a method and a device for tracking photographing.

### BACKGROUND

Nowadays, a movable device with a photographing component is widely used. For example, an unmanned aerial vehicle (UAV) with a camera can track and shoot a desired object and transmit the captured image to a user in real time.

During a tracking process in existing technology, when a user selects a tracking target, the movable device sets its camera in a global average focus mode. That is, it is necessary to ensure not only clear imaging of the tracking target, but also clear imaging of other objects in a same frame as the tracking target. In addition, the camera adopts global average metering when tracking and shooting the target.

However, when it is desired to capture an image in which a target object is clear and the background is blurred, the existing tracking and shooting mode cannot meet such a demand, because in the existing tracking and shooting technology, the camera uses global average focus. In addition, because the current tracking and shooting mode uses a global average metering method, the tracking target may appear too dark or too bright in a high-contrast scenario, resulting in a poor-quality image.

### SUMMARY

In accordance with the disclosure, there is provided a movable device. The movable device includes a sensing element configured to obtain position information of a target object; an image acquisition element configured to capture an image containing the target object; and a controller. The controller is configured to adjust an orientation of the image acquisition element to face toward the target object; receive the image from the image acquisition element; control the image acquisition element to perform, according to the position information of the target object, at least one of: setting focus on the target object, or metering the target object.

Also in accordance with the disclosure, there is provided a control device, including a receiving component configured to receive an image from a movable device, the image being collected by the movable device; a display component configured to display the received image; and an information input component configured to obtain the user instruction. The control device also includes: a processor configured to, according to the user instruction, identify a to-be-tracked object in the image, and use the identified object as the target object for taking a tracking shot, and for at least one of focusing or metering; and a transmission component configured to: send an instruction message to a movable device to instruct the movable device to take a tracking shot of the target object and performing at least one of: setting focus on the target object or metering the target object.

Also in accordance with the disclosure, there is provided a movable device and a control device in communication with the movable device. The control device includes a receiving component configured to receive an image from a movable device, the image being collected by the movable device; a display component configured to display the received image; and an information input component configured to obtain the user instruction. The control device also includes: a processor configured to, according to the user instruction, identify a to-be-tracked object in the image, and use the identified object as the target object for taking a tracking shot, and for at least one of focusing or metering; and a transmission component configured to: send an instruction message to a movable device to instruct the movable device to take a tracking shot of the target object and performing at least one of: setting focus on the target object or metering the target object. Further, the movable device includes a sensing element configured to obtain position information of a target object; an image acquisition element configured to capture an image containing the target object; and a controller. The controller is configured to adjust an orientation of the image acquisition element to face toward the target object; receive the image from the image acquisition element; control the image acquisition element to perform, according to the position information of the target object, at least one of: setting focus on the target object, or metering the target object.

### BRIEF DESCRIPTION OF THE DRAWINGS

In order to better describe the embodiments of the present disclosure and their advantages, reference will now be made to the following description in accordance with the accompanying drawings.

FIGS. 1 is a block diagram of an example movable device according to an example embodiment.

FIG. 2 is a flow chart of a method implemented by a movable device according to an example embodiment.

FIG. 3 is a schematic block diagram of a control device according to an example embodiment.

FIG. 4 is a flow chart of a method implemented by a control device according to an example embodiment.

FIGS. 5A-5D are schematic diagrams illustrating tracking photographing applications according to at least one example embodiment.

In addition, the drawings are not necessarily drawn to scale, but are shown only in a schematic manner that does not affect the reader's understanding.

### DETAILED DESCRIPTION OF THE EMBODIMENTS

Technical solutions of the present disclosure will be described with reference to the drawings. Other aspects, advantages, and prominent features of the present disclosure will become apparent to those skilled in the art. In addition, descriptions of well-known technology not directly related to the present disclosure are omitted for clarity and conciseness.

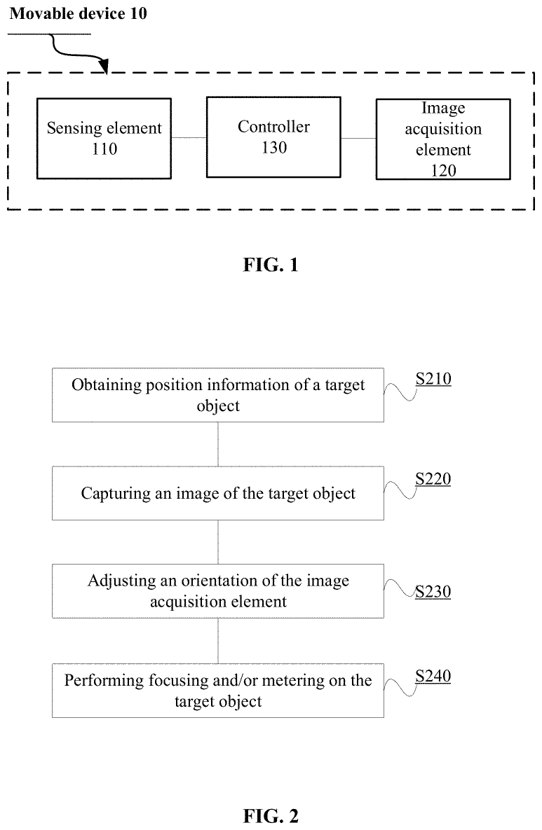

FIG. 1 is a block diagram illustrating a movable device 10 according to an example embodiment of the present disclosure. As shown in FIG. 1, the movable device 10 includes a sensing element 110, an image acquisition element 120, and a controller 130.

The movable device 10 may have various forms including, but not limited to, an unmanned aerial vehicle (UAV), an unmanned car, or an unmanned ship. Hereinafter, the principles of the present disclosure will be described by taking a UAV as an example of the movable device 10. Those skilled in the art can appreciate that the described principles can be adapted to other forms of movable devices as well.

The sensing element 110 may be configured to acquire position information of a target object. Here, a “target object” may refer to an object that is of interest to a user and needs to be tracked for shooting. In addition, the sensing element 110 can also be configured to obtain position information of the movable device 10 itself. Examples of the sensing element 110 may include one or more of a Global Positioning System (GPS) sensor, a vision sensor, an ultrasonic sensor, an infrared sensor, or a radar.

The image acquisition element 120 may be configured to capture an image of a target object. For example, the image acquisition element 120 may include one or more cameras configured to capture photo(s) or video(s) of the target object in real time. In one embodiment, the image acquisition element 120 is a visible light camera. It can be understood that the image acquisition element 120 may also include other type(s) of devices that can capture images and/or videos, such as an infrared camera, a stereoscopic camera, etc. In some embodiments, the movable device 10 may include a gimbal, and the image acquisition element 120 may be a payload attached to the gimbal.

The controller 130 may be configured to adjust an orientation of the image acquisition element 120 to face the target object. In this way, the images captured by the image acquisition element 120 may always include the target object. For example, the target object may move frequently and the movement may be irregular, the movable device 10 may operate in a tracking shooting (also referred as tracking photographing) mode to follow the target object and obtain images of the target object. The controller 130 may be configured to continuously obtain real-time position information of the target object sensed by the sensing element 110, and adjust the orientation of the image acquisition element 120 based on the position information, so that the image acquisition element 120 can track and shoot the target object at all times.

In an example embodiment, the controller 130 is configured to control the image acquisition element 120 to set focus on the target object and/or perform metering for shooting the target object according to the position information of the target object sensed by the sensing element 110 (e.g., in response to an instruction message received from a control device). For example, the image acquisition element 120 may be configured to receive a control instruction from the controller 130 and start or stop setting focus on and/or metering the target object according to the received control instruction. Performing (local) metering on the target object may refer to partial metering, spot metering, or any other proper metering method performed on a specific object or region, i.e., the target object.

In some embodiments, if it is desired to achieve local focus only on the target object, the controller 130 may be configured to control the image acquisition element 120 to set a focus point on the tracked target object according to the position information of the target object. In this way, in the image acquired by the image acquisition element 120, the target object itself is clear, and there is no need to consider whether focuses of objects in the image other than the target object is clear. When shooting with a large aperture, the degree of background blur is relatively high. When shooting with a small aperture, the degree of background blur is relatively low. Appropriate aperture values can be selected to achieve desired extent of background blurring.

In some embodiments, if it is desired to implement local metering on the target object (i.e., metering or measuring light intensity in an area where the target object is located, and determining, based on the measuring result, exposure such as shutter speed and aperture for the image acquisition element 120), the image acquisition element 120 may be configured to receive a control instruction from the controller 130 according to the position information of the target object, detect a brightness at the target object (e.g., measure a light reflected from the position of the target object), and adjust a brightness of the entire image according to the brightness at the target object (e.g., properly expose the area where the target object is located regardless of overall lighting condition). In this way, it is possible to ensure that the brightness of the target object is appropriate in the entire image frame, so that the target object is clear and legible.

Optionally, the image acquisition element 120 may be configured to compensate the brightness of the target object after metering the target object, and set the brightness of the entire image based on the brightness of the target object after compensation. For example, two thresholds can be set: a first threshold and a second threshold, where the first threshold is smaller than the second threshold. These two thresholds may be predetermined or may be continuously adjusted during the tracking photographing process. The image acquisition element 120 can be configured to: when the brightness of the target object is less than the first threshold, perform compensation (e.g., changing exposure level) to increase the brightness of the target object; and when the brightness of the target object is greater than the second threshold, perform compensation to reduce the brightness of the target object. The increased or decreased value can be set according to actual needs. In this way, the brightness of the target object after compensation is not too dark or too bright, and the brightness of the entire image adjusted based on the brightness of the target object may also be more appropriate.

In some embodiments, the controller 130 may be further configured to control the image acquisition element 120 to zoom in or zoom out according to the position information of the target object, so as to achieve enlargement or reduction of a scene captured in the image. In this way, the user can adjust the size of the target object as needed. When receiving an instruction message to view details of the target object, the controller 130 may be configured to control the image acquisition element 120 to zoom in, so that the target object occupies larger area in a captured image, which is convenient for the user to view the details of the target object. When receiving an instruction message to view an overall environment surrounding the target object, the controller 130 may be configured to control the image acquisition element 120 to zoom out, so that more information can be contained in the captured image, and it is convenient for the user to view the environment around the target object.

In some embodiments, the controller 130 may also be configured to control the image acquisition element 120 to adjust at least one of a white balance or a color filter. For example, a fixed white balance setting may not produce good images due to different weather conditions. The controller 130 may control the image acquisition element 120 to adjust setting of at least one of the white balance or the color filter according to a surrounding lighting conditions to obtain better image quality and/or a desired image style.

In some embodiments, the controller 130 may be further configured to control the movable device 10 to follow the target object and maintain a preset distance from the target object. In addition, the controller 130 may be configured to adjust at least one of an orientation of the image acquisition element 120 or an orientation of the movable device 10 to make the image acquisition element 120 face the target object. In one embodiment, the orientation of the movable device 10 may remain unchanged while the orientation of the image acquisition element 120 is adjusted to face the target object. This configuration makes it easier to capture the target object being tracked. The controller 130 may also be configured to control the movable device 10 to stay at a specific position, and control the image acquisition element 120 to adjust the orientation in real time to capture the target object.

It can be understood that the above-mentioned local focusing and local metering technologies of the present disclosure can be applied individually or in combination. In addition, one or more of the above-mentioned lens adjustment (zooming in or out), white balance setting, or color filter setting may be applied together with local focus and/or metering.

With the technical solution of the present disclosure, a combination of intelligent tracking shooting and local focusing and/or local metering can be achieved through a simple interactive manner. In the tracking shooting mode, focusing and/or metering directed to the tracked target object are performed, and an area outside the tracked target object may be blurred and/or the captured image may have a suitable brightness (e.g., to present the target object clearly).

FIG. 2 is a flowchart illustrating a method performed by a movable device according to an embodiment of the present disclosure. For example, the method may be performed by the movable device 10 shown in FIG. 1. For the sake of simplicity, the detailed description of the movable device 10 is omitted below.

As shown in FIG. 2, at S210, position information of a target object is acquired through a sensing element. In addition, the sensing element can also obtain position information of the movable device. As described above, the sensing element may include one or more of a GPS sensor, a vision sensor, an ultrasonic sensor, an infrared sensor, or a radar.

At S220, an image including the target object is captured by an image acquisition element. For example, an image including the target object may be captured in real time by one or more cameras operably coupled to a movable device.

At S230, a controller adjusts an orientation of the image acquisition element to face the target object, so that the image acquisition element can acquire images including the target object. In some embodiments, the orientation of the image acquisition element is adjusted to make the target object appear in a center area of the captured image.

At S240, the image acquisition element is controlled to perform, according to the position information of the target object, at least one of: setting focus on the target object, or metering the target object. As mentioned above, focusing and metering can be applied individually or in combination. In addition, the focusing and/or metering may can also be implemented in combination with at least one of: lens adjustment (e.g., zoom in or zoom out), white balance setting, or color filter setting as described above, which will not be repeated in detail here.

The movable device and the method performed by the movable device according to some embodiments of the present disclosure have been described. Hereinafter, a control device that operates in correspondence with the movable device and a method performed by said control device will be described in detail.

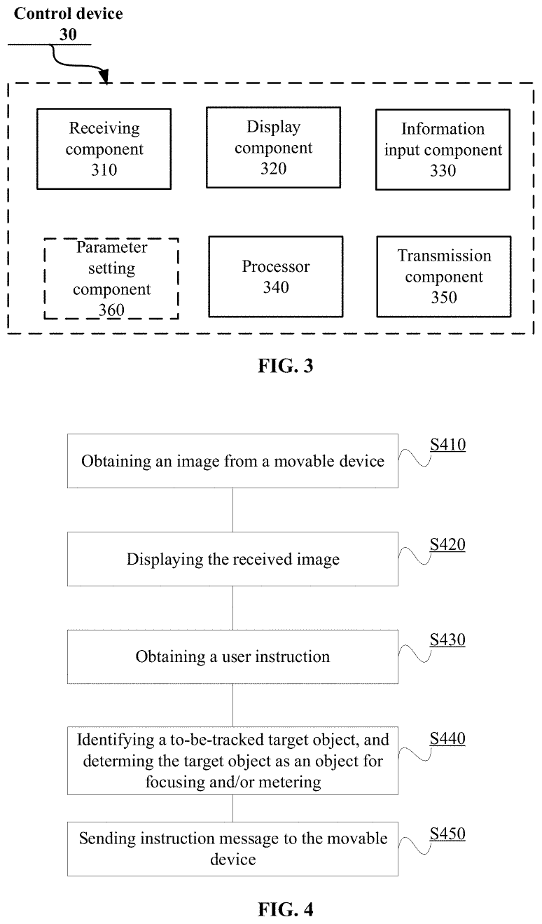

FIG. 3 is a block diagram illustrating a control device according to an embodiment of the present disclosure. As shown in FIG. 3, the control device 30 may include a receiving component 310, a display component 320, an information input component 330, a processor 340, and a transmission component 350.

The control device 30 may be various forms of devices, including but not limited to a smart phone, a control terminal, a tablet PC, a PAD, and the like. Hereinafter, the principle of the present disclosure will be described using a smartphone as an example of the control device 30. Those skilled in the art can understand that the described principles can also be applied to other forms of control device.

The receiving component 310 is configured to receive an image from a movable device. The display component 320 is configured to display the received image.

The information input component 330 is configured to obtain a user instruction input by a user. For example, the information input component 330 may include a touch screen, control key(s), control console, and/or the like. The user instruction input by the user may include at least one of: instructing the movable device to enter a tracking photographing mode to follow/track and shoot images (or video) of the target object, instructing the movable device to set focus on the target object, or instructing the movable device to meter the target object as described above.

The processor 340 is configured to identify a to-be-tracked object in an image according to the user instruction, and use the identified object as the target object for taking a tracking shot, focusing and/or metering.

The transmission component 350 is configured to send an instruction message to the movable device, instructing the movable device to capture the target object and perform at least one of setting focus on the target object or performing local metering on the target object. In one example, the information input component 330 is configured to obtain a selection instruction made by the user on the display component 320 (e.g., selecting an area in the image shown on the display component 320), and the processor 340 is configured to identify one or more objects in the selected area, and determine, from the one or more identified objects, one object that meets a preset condition as a target object. Alternatively, the processor 340 may be configured to set a frame indicated by the selection instruction directed to the target object as a focusing frame for focusing and/or as an area for local metering.

In addition, the receiving component 310 may also be configured to receive real-time position information of the target object from the movable device, and the display component 320 may be configured to display the real-time position information of the target object.

As used herein, the “target object” refers to an object that is of interest to the user and a target for a tracking shot. The image acquisition element of the movable device may capture a candidate image of a scene and sends the candidate image to the control device 30. The user of the control device 30 determines the target object in the candidate image by, for example, selecting an area in the candidate image containing or outlining the target object. That is, a selection instruction is received by the information input component 330 and the processor 340 determines the target object based on the selection instruction and control the transmission component 350 to inform the movable device about the target object (e.g., by sending an instruction message). After obtaining the instruction message sent by the transmission component 350, the movable device can use the image acquisition element (e.g., one or more cameras) to track and shoot the target object in real time. The movable device may obtain real-time position information of the target object through the sensing element, generate an image that includes the target object, and transmit the image to the control device 30. The movable device may also set focus on or meter the target object according to a received instruction message and the real-time position information.

Alternatively, the control device 30 may further include a parameter setting component 360 (shown by a dotted line in FIG. 3). The parameter setting component 360 may be configured to set parameters for metering, and the transmission component 350 may send the parameters set by the parameter setting component 360 to the movable device. It can be understood that the parameter setting component 360 may be a sub-component of the information input component 330 for configuring parameters.

For example, the parameters may include a compensation parameter for compensating a metering result of the target object. In some embodiments, two thresholds can be set: a first threshold and a second threshold, where the first threshold is smaller than the second threshold. These two thresholds may be predetermined or may be continuously adjusted during the tracking shooting process. When the brightness of the target object is less than the first threshold, the movable device performs compensation processing to increase the brightness of the target object. When the brightness of the target object is greater than the second threshold, the movable device performs compensation processing to reduce the brightness of the target object. The increased or decreased value can be set according to actual needs. In this way, the brightness of the target object after compensation in the captured image is not too dark or too bright, and the brightness of the entire image adjusted based on the brightness may also be more appropriate.

In some embodiments, after the to-be-tracked object is identified, the processor 340 is configured to generate instruction message that informs the movable device to track the target object according to the user instruction. For example, the instruction message may be used to instruct the image acquisition element of the movable device to face the target object. For example, the orientation of the movable device itself does not change, but only the orientation of the image acquisition element is adjusted.

In some embodiments, the instruction message may instruct the movable device to control both the movable device and the image acquisition element to face the target object. Upon receiving this instruction message, both the movable device itself and the image acquisition element included therein are adjusted to be oriented toward the target object. Optionally, when the instruction message is used to instruct both the movable device and the image acquisition element to orient toward the target object, the instruction message may be further configured to instruct the movable device to follow the target object and maintain a preset distance from the target object.

FIG. 4 is a flowchart illustrating a method performed by a control device according to an embodiment of the present disclosure. For example, the method may be performed by the control device 30 shown in FIG. 3. For simplicity, the detailed description of the control device 30 is omitted below.

As shown in FIG. 4, at S410, an image acquired by the movable device is received from the movable device. At S420, the received image is displayed.

At S430, a user instruction input by a user is acquired. At S440, a to-be-tracked object is identified in the image according to the user instruction, and the identified object is used as a target object for focusing and/or metering. For example, a selection instruction made by a user on the display component may be obtained, one or more objects in an area corresponding to the selection instruction may be identified, and among the one or more objects, an object meeting a preset condition may be used as the target object. The preset condition may be, for example, number of pixels representing the object is greater than a certain percentage (e.g., 50%) of total number of pixels in the selected area. In some embodiments, a frame indicated by the selection instruction directed to the target object may be used as a focusing frame for focusing and/or as an area for local metering.

At S450, an instruction message is sent to the movable device, instructing the movable device to track and capture the target object (e.g., taking one or more tracking shots of the target object), and to set focus on the target object and/or meter the target object.

In some embodiments, after the to-be-tracked object is determined, according to the user instruction, an instruction message configured to instruct the movable device to track the target object may be generated and sent to the movable device. For example, the instruction message may include instruction of directing the image acquisition element of the movable device toward the target object, or controlling both the movable device and the image acquisition element to face toward the target object. In some embodiments, when the instruction message includes the instruction of controlling both the movable device and the image acquisition element to face toward the target object, the instruction message may further include an instruction of controlling the movable device to follow the target object and maintain a preset distance from the target object.

In some embodiments, parameters for metering may be set and the set parameters are transmitted to the movable device. For example, the parameters may include a compensation parameter for compensating a metering result of the target object, as described above.

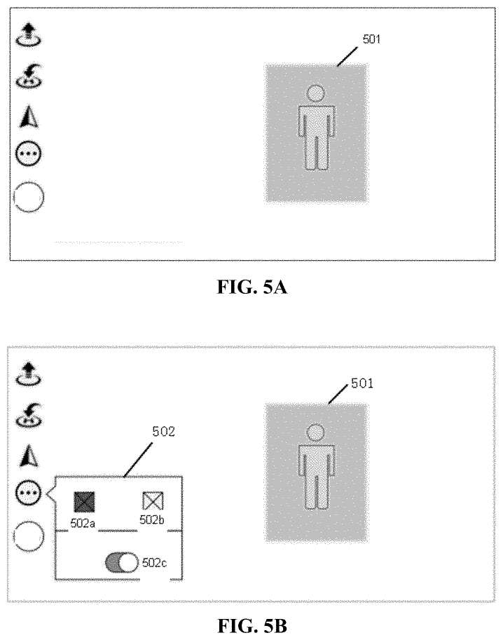

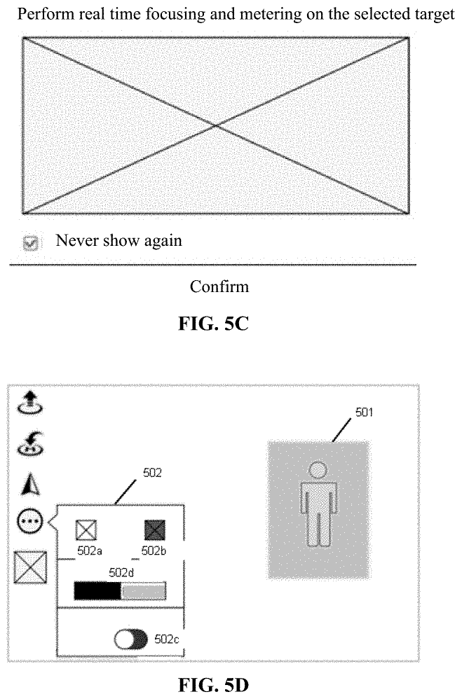

Hereinafter, scenarios of tracking photographing applications according to some embodiments of the present disclosure will be described in detail with reference to FIGS. 5A-5D. In FIGS. 5A-5D, a smart phone is taken as an example of the disclosed control device, and a UAV is taken as an example of the disclosed movable device to explain the principle of the technical solution of the present disclosure. However, those skilled in the art can understand that the principles of the present disclosure can be implemented in other types of control devices and movable devices.

FIGS. 5A-5D illustrate contents being displayed on a screen on a smartphone.

As shown in FIG. 5A, a user may select an area containing a person in an image shown on the smartphone screen as a target object to be tracked. Accordingly, the target object is determined as an area/region indicated by reference numeral 501. Although the selected target object in FIG. 5A is near the center of the screen, those skilled in the art can understand that the position of the target object is not limited, but may be at any position on the screen.

As shown in FIG. 5B, when a circular button with dots inside (e.g., the fourth one from top to bottom) in a menu bar on the left side of the screen is selected, and an option box 502 is displayed. In the option box 502, a plurality of option buttons 502a, 502b, and 502c are included. The option button 502a is configured to enable or disable tracking photographing function of the UAV. The option button 502b is configured to enable or disable payload tracking function of the UAV. The payload may be an image acquisition element of the UAV (e.g., a camera whose orientation is controlled by a gimbal connected to the camera and attached to a body of the UAV). The option button 502c is configured to enable or disable a function of setting focus on the target object and/or a function of metering the target object. The user can select or unselect the button(s) in the option box 502 corresponding to the desired function(s) to be performed. In some embodiments, when implementing the function corresponding to the button 502a, the nose of the UAV and the image acquisition element are both oriented toward the target object; and when implementing the function corresponding to the button 502b, only the image acquisition element is oriented toward the target object, and the UAV maintains its original orientation or is oriented toward other direction.

For example, the user may have selected the area 501 as the to-be-tracked target object, and would like the UAV to set focus on the area and/or meter the area, thereby generating a picture/image associated with a tracked shooting function. Accordingly, the user may first select (e.g., click or touch) the button 502a to enable the tracking function of the UAV, and then click the option button 502c to activate the local focus and metering function of the UAV. In other words, selecting the option button 502c can cause the UAV to set focus and/or perform metering only the area 501 (e.g., the target object) and generate a real-time tracking image based on the results of the focusing and/or metering.

In some embodiments, after the user selects the button 502c, a dialog box may pop up on the smartphone screen, as shown in FIG. 5C. This dialog prompts the user that the UAV is going to set focus on the target object and/or perform metering on the target object. In this way, users are reminded about the function being implemented when selecting the button for the first time. If the user does not want to view the dialog again when the button 502c is selected in the future, the user can check the box in front of “Don't show again”. In this way, the next time the user selects button 502c to enable local focus and /or metering function, the dialog box shown in FIG. 5C does not pop up.

Further, if the user no longer wants the UAV to perform the local focus and/or metering function, the user can select the button 502c again to disable the function.

FIG. 5D shows content similar to FIG. 5B, except that the option box 502 further includes an option button 502d. The option button 502d is used to control a flight status of the UAV, including: following the target object and maintaining a preset distance from the target object; maintaining current position of the UAV, and adjusting the orientation of the image acquisition element (such as a camera) to face the target object, and when the target object is moving, adjusting the image acquisition element in real time to ensure that the image acquisition element can always capture the target object.

In an example embodiment, the user can control, on a smartphone, the UAV to enable a tracking shooting function, and conveniently enable or disable the local focus and metering function during the tracking shooting process, so that the UAV is capable of shooting images with blurred background, and the target object can be more prominently presented in the shot image. In addition, users can view the images taken by the UAV in real time on their smartphones. Optionally, the user can also view a location of the target object and/or location of the UAV in real time on the smartphone.

The method and related device of the present disclosure have been described above in connection with the various embodiments. Those skilled in the art can understand that the described embodiments are only exemplary. The methods of the present disclosure are not limited to the steps and sequences shown above.

It should be understood that the above-mentioned embodiments of the present disclosure may be implemented by software, hardware, or a combination of both software and hardware. These implementations may be provided as software, code, and/or other data structures configured or encoded on a computer-readable medium such as an optical medium (e.g., a CD-ROM), a floppy disk, or a hard disk, firmware or microcode on one or more ROM, RAM or PROM chips, downloadable software images in one or more modules, shared databases, etc. Software or firmware or such configuration may be installed on a computing device and be executed by one or more processors in the computing device, so as to implement the technical solutions described in the embodiments of the present disclosure.

In addition, each functional module or individual feature of the device used in each of the above embodiments may be implemented or performed by a circuit, and the circuit may include one or more integrated circuits. Circuits configured to perform the functions described in the present disclosure may include at least one of a general purpose processors, a digital signal processors (DSP), an application specific integrated circuit (ASIC) or a general purpose integrated circuit, a field programmable gate array (FPGA) or other programmable logic devices, a discrete gate or transistor logic, or a discrete hardware component, or any combination of the aforementioned components. The general-purpose processor may be a microprocessor, or the processor may be an existing processor, controller, microcontroller, or state machine. The above-mentioned general-purpose processor or each circuit may be configured by a digital circuit, or may be configured by a logic circuit. In addition, when an advanced technology capable of replacing a current integrated circuit appears due to advances in semiconductor technology, the present disclosure may also use integrated circuits obtained using the advanced technology.

The program running on a device according to the present disclosure may be a program that causes a computer to realize the functions of the embodiments of the present disclosure by controlling a central processing unit (CPU). The program or the information processed by the program may be temporarily stored in volatile memory (such as random access memory RAM), hard disk drive (HDD), non-volatile memory (such as flash memory), or other memory systems. A program for implementing the functions of the embodiments of the present invention may be recorded on a computer-readable storage medium. A computer system may read programs recorded on the storage medium and execute the programs to implement corresponding functions. The computer system, as used herein, may be a computer system embedded in the device, and may include at least one of an operating system or hardware (such as a peripheral device).

The above description of the disclosed embodiments and accompanying drawings enable those skilled in the art to implement or use the present application. Various modifications to these embodiments will be apparent to those skilled in the art, and the general principles defined herein may be implemented in other embodiments without departing from the spirit or scope of the application.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A movable device comprising:
a sensing element configured to obtain position information of a target object;
an image acquisition element configured to capture an image containing the target object; and
a controller configured to:
adjust an orientation of the image acquisition element to face toward the target object;
receive the image from the image acquisition element;
control the image acquisition element to perform, according to the position information of the target object, at least one of: setting focus on the target object, or metering the target object.

2. The device of claim 1, wherein the image acquisition element is further configured to:
receive a control instruction from the controller; and
initiate or stop, in response to the control instruction, at least one of setting focus on the target object, or metering the target object.

3. The device of claim 1, wherein:
the sensing element is further configured to obtain real time position information of the target object.

4. The device of claim 1, wherein:
the sensing element is further configured to obtain position information of the target object and position information of the movable device.

5. The device of claim 1, wherein:
the sensing element comprises at least one of a Global Positioning System (GPS) sensor, a vision sensor, an ultrasonic sensor, an infrared sensor, or a radar.

6. The device of claim 1, wherein the image acquisition element is further configured to:
receive a control instruction from the controller;
obtain a local brightness of an area where the target object is located; and
adjusting a brightness of the entire image according to the local brightness.

7. The device of claim 6, wherein the image acquisition element is further configured to:
after metering the target object, compensate the local brightness corresponding to the target object; and
setting the brightness of the entire image based on the compensated brightness of the target object.

8. The device of claim 7, wherein the image acquisition element is further configured to:
if the local brightness of the target object is smaller than a first threshold, increasing the local brightness of the target object; and
if the local brightness of the target object is greater than a second threshold, reducing the local brightness of the target object,
wherein the second threshold is greater than the first threshold.

9. The device of claim 8, wherein the first threshold and the second threshold are predetermined or adjustable.

10. The device of claim 1, wherein the controller is further configured to control the image acquisition element to zoom in or zoom out based on the position information of the target object.

11. The device of claim 1, wherein the controller is further configured to control the image acquisition element to adjust at least one of a white balance or a color filter.

12. The device of claim 1, wherein the controller is further configured to control movable device to follow the target object and keep a preset distance from the target object.

13. The device of claim 1, wherein the controller is further configured to, during a process of adjusting the orientation of the image acquisition element to face toward the target object; maintain an orientation of the movable device or adjust the orientation of the movable device to also face toward the target object.

14. The device of claim 1, wherein the movable device comprises an unmanned aerial vehicle, an unmanned car, or an unmanned ship.

15. A control device comprising:
a receiving component configured to receive an image from a movable device, the image being collected by the movable device;
a display component configured to display the received image;
an information input component configured to obtain a user instruction;
a processor configured to, according to the user instruction, identify a to-be-tracked object in the image, and use the identified object as the target object for taking a tracking shot, and for at least one of focusing or metering; and
a transmission component configured to: send an instruction message to a movable device to instruct the movable device to take a tracking shot of the target object and performing at least one of: setting focus on the target object or metering the target object.

16. The device of claim 15, wherein:
the information input component is further configured to obtain a selection instruction shown by the display component; and
the processor is configured to identify one or more objects within an area designated by the selection instruction, and determine one of the one or more objects satisfying a preset condition as the target object.

17. The device of claim 16, wherein:
the selection instruction is configured to specify a target frame containing the target object;
the processor is further configured to designate the target frame as at least one of: an object for focusing or an area for metering.

18. The device of claim 15, wherein:
the receiving component is further configured to receive real time location information of the target object; and
the display component is further configured to display the real time location information of the target object.

19. The device of claim 15, further comprising:
a parameter setting component configured to set one or more parameters for metering the target object.

20. A tracking photographing system comprising:
a movable device; and
a control device in communication with the movable device, comprising:
a receiving component configured to receive an image from the movable device, the image being collected by the movable device;
a display component configured to display the received image;
an information input component configured to obtain a control instruction input by a user;
a processor configured to, according to the control instruction, identify a to-be-tracked object in the image, and use the identified object as the target object for taking a tracking shot, and for at least one of focusing or metering; and
a transmission component configured to: send an instruction message to a movable device to instruct the movable device to take a tracking shot of the target object and performing at least one of: setting focus on the target object or metering the target object;
wherein the movable device comprises:
a sensing element configured to obtain position information of the target object;
an image acquisition element configured to capture the image containing the target object; and
a controller configured to:
adjust an orientation of the image acquisition element to face toward the target object;
receive the image from the image acquisition element;
control the image acquisition element to perform, according to the position information of the target object, at least one of: setting focus on the target object, or metering the target object.
